(19) United States
(12) Patent Application Publication
(10) Pub. No.: US 2019/0098701 A1
(43) Pub. Date: Mar. 28, 2019

(54) DotDot Gateway

(71) Applicant: Silicon Laboratories Inc., Austin, TX (US)

(72) Inventors: DeWitt Clinton Seward, Arlington, MA (US); Greg Hodgson, Austin, TX (US); Clay Daigle, Austin, TX (US); Preston Fick, Austin, TX (US); John Hemmick, Austin, TX (US)

(21) Appl. No.: 15/717,008

(22) Filed: Sep. 27, 2017

(51) Int. Cl. H04W 88/16; H04L 12/66; H04L 29/12

(52) U.S. Cl. CPC H04W 88/16; H04L 61/6077; H04L 61/251; H04L 12/66

(57) ABSTRACT

A system and method for allowing legacy devices to operate on a IPv6 network is disclosed. The system includes a gateway device to interfaces between DotDot devices and legacy devices. In some embodiments, the gateway device has a plurality of network interfaces to communicate with these legacy devices. The gateway device discovers the legacy devices that it can communicate with. The gateway device then enumerates these legacy devices in a manner that allows them to be accessed by the DotDot device. In certain embodiments, the gateway device enumerates each legacy device as a unique IPv6 address.

### BACKGROUND

The explosion of network connected devices has led to an increased use of certain protocols. ZigBee Cluster Library over IP (ZCLIP), also referred to as DotDot, is a new standard intended to improve the security and universal connectivity of the Internet of Things (IoT). As the adoption of DotDot continues to grow, there will be an entire set of infrastructure developed to allow communication between DotDot devices and the cloud, which includes PCs, smart phones, cloud servers and other devices. DotDot is an application layer which may be utilized with different network layers. One such network layer is known as Internet Protocol (IP). Further, there are two versions of Internet Protocol; version 4 (IPv4) and version 6 (IPv6).

However, there are already millions of devices that communicate wirelessly using other protocols, such as ZigBee®, BlueTooth, BLE and others. For example, ZIGBEE® is now commonly used in many applications, including utility meters, lighting systems and the like.

There is a need to find a way in which the currently existing devices, which do not utilize the DotDot protocol, can be included as part of a DotDot network. Obviously, retrofitting all of these existing devices with new software and possibly new hardware is not feasible for many reasons.

Therefore, there needs to be a system and method that allows these legacy devices to operate on a DotDot network using IPv6, without requiring any changes to these legacy devices. However, there are now security requirements associated with the DotDot protocol that complicate this objective. Consequently, it would be beneficial to have a system and method that allows legacy devices to operate on a DotDot network without compromising the security of the DotDot network.

### SUMMARY

A system and method for allowing legacy devices to operate on a DotDot network using IPv6 is disclosed. The system includes a gateway device to interface between DotDot devices and legacy devices. In some embodiments, the gateway has a plurality of network interfaces to communicate with these legacy devices. The gateway device discovers the legacy devices that it can communicate with. The gateway device then enumerates these legacy devices in a manner that allows them to be accessible to the DotDot device. In certain embodiments, the gateway device enumerates each legacy device with a globally unique IPv6 address.

According to one embodiment, a gateway device is disclosed. The gateway device comprises a DotDot network interface; a secondary network interface; a processing unit and a memory device, where the memory device comprises instructions, which when executed by the processing unit, allow the gateway device to: enumerate a legacy device using the secondary network interface; obtain a IPv6 address for the legacy device; claim any communication for the IPv6 address occurring on the DotDot network interface; translate the communication to a network protocol used by the secondary network interface; and transmit the translated communication using the secondary network interface to the legacy device. In certain embodiments, the second network interface supports an IEEE802.15.4 network protocol or a BLUETOOTH® network protocol. In some embodiments, the IPv6 address of the legacy device is different than an IPv6 address of the gateway device. In certain embodiments, the gateway device obtains the IPv6 address by accessing a DHCP server. In certain embodiments, the gateway device utilizes Stateless Address Autoconfiguration to obtain the IPv6 address.

According to another embodiment, a method of configuring a legacy device to operate on a DotDot network is disclosed. The method comprises using a gateway device to communicate to the legacy device using a secondary network interface; assigning a unique IPv6 address to the legacy device; translating a communication from a DotDot device to the unique IPv6 address to a legacy protocol; and using the secondary network interface to transmit the translated communication to the legacy device. In certain embodiments, the gateway device creates an internal mapping associating the unique IPv6 address with the legacy device. In some embodiments, the secondary network interface utilizes a ZIGBEE® protocol or a BLUETOOTH® protocol. In certain embodiments, the gateway device obtains the unique IPv6 address from a DHCP server. In certain embodiments, the gateway device obtains the unique IPv6 address using stateless address autoconfiguration. According to another embodiment, a gateway device is disclosed. The gateway device comprises a DotDot network interface; a secondary network interface; a processing unit and a memory device, where the memory device comprises instructions, which when executed by the processing unit, allow the gateway device to: create a pool of unique IPv6 addresses using Stateless Address Autoconfiguration; enumerate a legacy device using the secondary network interface; assign a first of the unique IPv6 addresses to the legacy device; and claim any communication for the first IPv6 address occurring on the DotDot network interface. In some embodiments, the gateway device further comprises instructions, which when executed by the processing unit, allow the gateway device to: translate the communication to a network protocol used by the secondary network interface; and transmit the translated communication using the secondary network interface to the legacy device. In certain embodiments, the secondary network interface supports an IEEE802.15.4 network protocol or a BLUETOOTH® network protocol.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a gateway device according to one embodiment;

FIG. 2 shows the gateway device of FIG. 1 in one implementation; and

FIG. 3 illustrates a flowchart showing the initialization of the gateway device according to one embodiment.

### DETAILED DESCRIPTION

As described above, DotDot is an emerging network protocol that allows communication over IP. While intended for wireless communications to support the Internet of Things (IoT), it is also usable over wired connections. The DotDot specification describes a generic application layer which can be used with different network stacks. For example, Thread is actively working on a network stack that is compatible with DotDot. DotDot defines an application layer. This application layer is similar to that already defined by the ZIGBEE® protocol. Stated differently, DotDot does not mandate a particular physical interface, but does mandate a specific application layer. In many embodiments, DotDot utilizes a network layer that relies on the Internet Protocol (IP). This network layer may be Internet Protocol version 4 (IPv4) or Internet Protocol version 6 (IPv6). However, these legacy devices do not support IPv6. Therefore, the gateway device needs to provide this functionality.

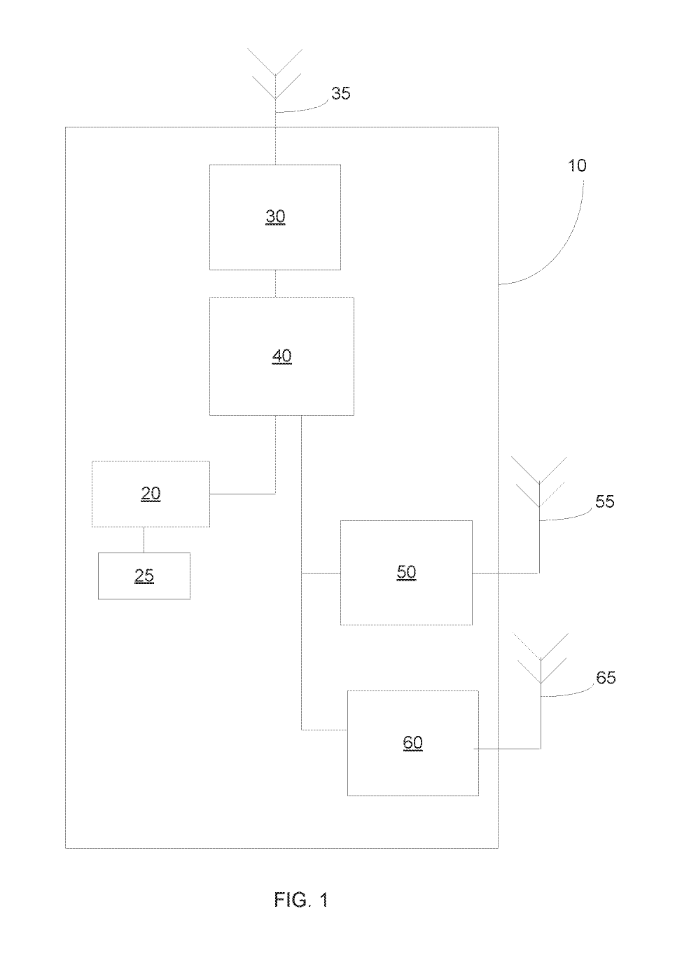

FIG. 1 shows a block diagram of a representative gateway device 10. The gateway device 10 has a processing unit 20 and an associated memory device 25. This memory device 25 contains the instructions, which, when executed by the processing unit 20, enable the gateway device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

The gateway device 10 also includes a IPv6 network interface 30, which may be a wireless interface including an antenna 35. As stated above, IPv6 defines a network layer. Therefore, the IPv6 network interface 30 may be any interface that supports the IPv6 protocol. For example, in certain embodiments, the IPv6 network interface 30 may be an ethernet network controller. In other embodiments, the DotDot network interface 30 may be a WIFI network controller. In other embodiments, the IPv6 network interface 30 may be a Thread network controller. Further, the IPv6 network may be used to support any application layer, such as TCP, UDP or DotDot. Thus, while the disclosure describes the gateway device with respect to DotDot, it is understood that the gateway device may be used to communicate with any application layer that utilizes IPv6.

In this disclosure, the IPv6 network interface 30 may be referred to as the primary network interface, while all other network interfaces are referred to as secondary network interfaces. Further, throughout this disclosure, the term “legacy device” is used to denote any device that does not use the IPv6 protocol.

The gateway device 10 may include a second memory device 40 in which data that is received by the IPv6 network interface 30, and data that is to be transmitted by the IPv6 network interface 30, is stored. This second memory device 40 is traditionally a volatile memory. The processing unit 20 has the ability to read and write the second memory device 40 so as to communicate with the other nodes in the network. Although not shown, the gateway device 10 also has a power supply, which may be a battery or a connection to a permanent power source, such as a wall outlet.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language and is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device, which is located remote from the gateway device 10. The instructions contained on this second computer readable media may be downloaded onto the memory device 25 to allow execution of the instructions by the gateway device 10.

The gateway device 10 may also include a second network interface 50. This second network interface 50 may support any wireless network, including ZIGBEE®, BLUETOOTH®, BLE, a cellular protocol, such as 3G, GCM, CDMA, 4G, LTE, or other protocols. The second network interface 50 may include a second antenna 55.

In certain embodiments, the gateway device 10 may include a third network interface 60 with a third antenna 65. For example, the second network interface 50 may support ZigBee® and the third network interface 60 may support another wireless protocol, such as BLE or BLUETOOTH®. In fact, an arbitrary number of secondary network interfaces may be disposed on the gateway device 10. For example, there may be a plurality of secondary network interfaces to support ZigBee®, BLUETOOTH®, BLE and others.

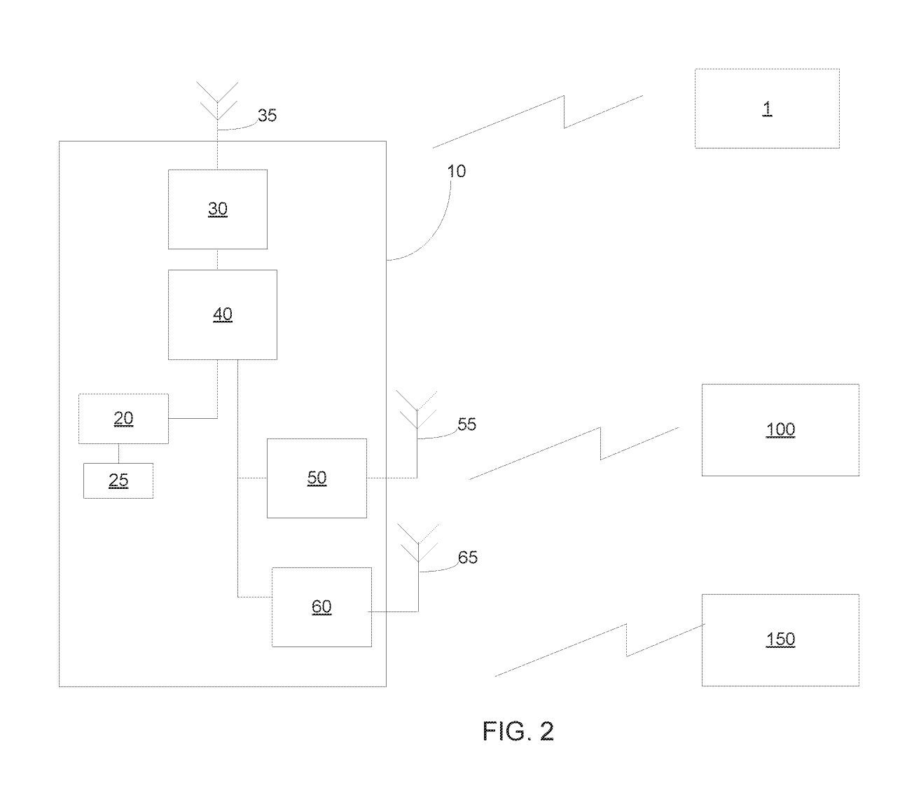

FIG. 2 shows the gateway device 10 in communication with a ZIGBEE® device 100. The gateway device 10 uses the existing ZIGBEE® standard to communicate with the ZIGBEE® device 100. As is well known, ZIGBEE® operates using the standard defined in IEEE 802.15.4. In other words, the IEEE 802.15.4 specification defines the physical and media access control layers of the network. The ZIGBEE® standard defines the higher level network protocols. The ZIGBEE® device 100 may be an end device or a sleepy device. The gateway device 10 serves as the parent node on the ZIBGBEE® network. The gateway device 10 may be a coordinator device or a router device. The second network interface 50 of the gateway device 10 provides the hardware support to communicate to the ZIGBEE® device 100.

FIG. 2 also shows the gateway device 10 in communication with a second network device 150. In certain embodiments, the third network interface 60 is used to communicate with the second network device 150. This second network device 150 may communicate using the BLUETOOTH® or BLUETOOTH® Low Energy (BLE) protocol, for example. In other embodiments, this second network device 150 may communicate using a different protocol, such as another protocol based on IEEE 802.15.4. In still other embodiments, the second network device 150 may not be present. In other embodiments, the ZIGBEE® device 100 is not present, and only the third network interface 60 is used. Further, the number of secondary network interfaces that may be disposed on the gateway device 10 is not limited by this disclosure. In other words, although the present disclosure describes a first network interface to communicate using the DotDot protocol with IPv6 and two secondary network interfaces, any number of secondary network interfaces may be employed. Further, the number of devices that communicate with the gateway device 10 is not limited by this disclosure.

Finally, FIG. 2 shows the gateway device 10 in communication with another IPv6 device 1. The gateway device 10 communicates with the IPv6 device using the IPv6 network interface 30. This IPv6 device 1 may be a DotDot device. As described above, the IPv6 network interface 30 may be WIFI, Ethernet or another other communication mechanism that utilizes the IP protocol. Further, as described above, the application layer may be DotDot, although other protocols may also be used.

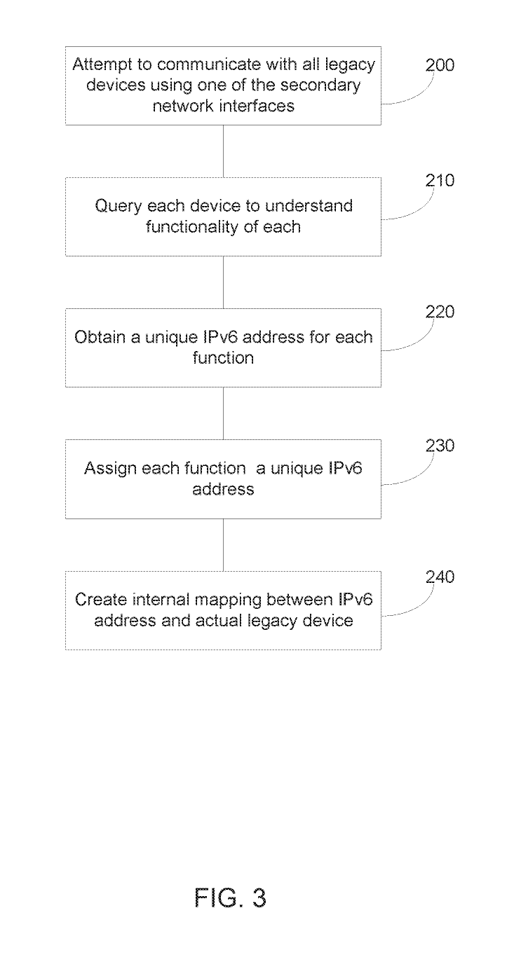

FIG. 3 shows a representative flowchart showing the initialization of the gateway device 10. In operation, the gateway device 10 uses a secondary network interface, such as the second network interface 50, to attempt to communicate with legacy devices, such as the ZIGBEE® device 100 and any other ZIGBEE® devices within its listening range, as shown in Box 200. Once the gateway device 10 has enumerated all of the ZIGBEE® devices, it then queries each device to understand its functionality, as shown in Box 210. For example, some ZIGBEE® devices may be sensors, others may be lighting devices, others may be switching devices to control the lighting devices. In certain embodiments, a ZIGBEE® device may have more than one function. For example, a ZIGBEE® device may be a combination occupancy sensor and thermostat device. Once the gateway device 10 has fully enumerated all of the devices in communication with the second network interface 50, and queried each device to understand its functions, it obtains a unique IPv6 address for each of these functions, as shown in Box 230. In other embodiments, IPv6 addresses may be assigned on a per device basis. In other words, regardless of the number of functions incorporated in a legacy device, only one IPv6 address is obtained for that legacy device. The gateway device 10 then assigns a unique IPv6 address to each function or device, as shown in Box 230.

The gateway device 10 also maintains an internal mapping between the IPv6 address and the address of the ZIGBEE® device associated with that IPv6 address, as shown in Box 240. This internal mapping may include an indication of the protocol used by the legacy device associated with that IPv6 address (or the network interface to be used to connect to the ZIGBEE® device associated with that endpoint), the address of the ZIGBEE® device associated with that IPv6 address, and other parameters. In this way, when a DotDot device accesses an IPv6 address that is part of the gateway device 10, the gateway device 10 is able to determine which external legacy device is associated with that IPv6 address.

This process is then repeated for each network interface disposed on the gateway device 10. Thus, if there is a third network interface 60, this sequence is repeated to identify all devices in communication with the third network interface 60. Further, if there are additional secondary network interfaces disposed on the gateway device 10, the process illustrated in FIG. 3 would be performed for each of those network interfaces.

Once the gateway device 10 has completed the initialization process shown in FIG. 3 for all of the network interfaces, it can then report its functionality to another node on the DotDot network, such as a mobile device, a cloud-based server, or any other gateway that presents itself as a DotDot device, including an actual DotDot gateway.

Once the gateway device 10 has been configured, it is able to be deployed in a DotDot network using IPv6 addresses. Advantageously, it also allows the operation of existing wireless devices that do not support DotDot protocol.

For example, assume that the gateway device 10 reported that it is connected to 8 other devices. These devices may include a combination of legacy devices, such as ZIGBEE® devices, BLE devices, BLUETOOTH® devices, and the like. These devices may also include functions that are internal to the gateway device 10. As an example, the devices may be defined as follows:

| Device Number | Function |
|---|---|
| 1 | Legacy ZigBee device #1 - light bulb |
| 2 | Legacy ZigBee device #2 - light bulb |
| 3 | Legacy ZigBee device #3 - light bulb |
| 4 | Legacy ZigBee device #4 - switch |
| 5 | Legacy ZigBee device #5 - occupancy sensor |
| 6 | Legacy ZigBee device #5 - thermostat |
| 7 | Legacy BLE device - smart sensor |

Having enumerating all of the devices that are in communication with the gateway device 10, the gateway device 10 can then assign each device or function a unique IPv6 address. This information is made available to other IPv6 devices by means typically used in IPv6 communications.

As described above, in order to operate, the gateway device 10 must obtain unique IPv6 addresses for each of the legacy devices. There are several ways in which this can be done. In one embodiment, the gateway device 10 may be in communication with a DHCPv6 server via the IPv6 network interface 30. The gateway device 10 may request an IPv6 address from the DHCPv6 server. In response, the DHCPv6 server may then determine a unique IPv6 address that can be used by the gateway device 10. This unique IPv6 address is then returned to the gateway device 10, which assigns it to one of the legacy devices. The gateway device 10 then repeats this process for each legacy device that it enumerated.

In another embodiment, the gateway device 10 may utilize stateless address autoconfiguration (SLAAC). In this embodiment, the gateway device 10 receives a network prefix from a local network router via a Router Advertisement. The Router Advertisement is received on the IPv6 network interface 30. This network prefix is then combined with other information to form the unique IPv6 address. In certain embodiments, the other information may include the MAC address of the gateway device 10. In the case of a gateway device 10, it is necessary to obtain a plurality of unique IPv6 addresses. The gateway device 10 would use the SLAAC information (i.e. the block of IPv6 addresses obtained) to generate an IPv6 address for each legacy device. The gateway device 10 may not need to do a full SLAAC procedure, as it has already reserved a certain number of addresses. Therefore, the gateway device 10 can simply assign these IPv6 addresses using any suitable mechanism. Once an IPv6 address has been assigned, the gateway device 10 will communicate this assigned address to the rest of the network.

While the above disclosure describes a method where the gateway device 10 obtains IPv6 addresses for each enumerated legacy device, other embodiments are also possible. For example, at boot time, the gateway device 10 may create a pool of available IPv6 addresses, using any of the techniques described above. The number of IPv6 addresses that are reserved may be a design implementation choice and is not limited by this disclosure. Then, when the legacy devices have all been enumerated, the gateway device 10 may assign IPv6 addresses to each of these legacy devices from its pool of available IPv6 addresses.

In addition to obtaining and assigning IPv6 addresses to each of the legacy deices, the gateway device 10 has other functions. Legacy devices typically do not initiate the connection to a server or other remote device. Rather, most legacy devices wait for a master or parent node to send a message to them. Therefore, unlike conventional gateways, the gateway device 10 of the present disclosure must initiate the connection to any public devices. Second, the gateway device 10 must assign IPv6 addresses differently than in traditional embodiments. Traditionally, each device is responsible for obtaining its own IPv6 address. In the present embodiment, the gateway device 10 must assign the IPv6 to the legacy devices.

Additionally, the gateway device 10 must respond to a plurality of IPv6 addresses on its IPv6 network interface 30. In other words, the gateway device 10 must respond to all of the IPv6 addresses that have been assigned to the legacy devices. For example, the gateway device 10 may have enumerated 9 legacy devices and assigned unique IPv6 addresses to each of these legacy devices. The gateway device 10 must respond to communications on its IPv6 network interface 30 that are addressed to any of these 9 addresses.

Certain legacy network protocols, such as ZIGBEE®, BlueTooth, and BLE may use physical connections that are different from those present on the DotDot network interface 30. In addition, these network protocols may utilize different network stacks than that used by the DotDot protocol. For those network protocols, the gateway device 10 needs to provide translation functionality, whereby the gateway device 10 converts packets from the DotDot protocol, which are addressed to a particular IPv6 address claimed by the gateway device 10, to a completely different network protocol. Thus, in the example shown above, any access to Devices 1-7 requires the gateway device 10 to translate the packet to a different protocol, having a different network layer and a different application layer.

Furthermore, the DotDot network interface 30 is described as being any network that utilizes the IPv6 protocol. It is noted that Thread is one such network. Thus, in some embodiments, the DotDot network interface 30 may support IEEE802.15.4 so as to support Thread.

This system has the benefit of allowing existing devices to be used as the migration toward DotDot continues. Thus, rather than having to replace these legacy devices, gateway devices allow these devices to remain fully operational.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A gateway device, comprising:
a DotDot network interface;
a secondary network interface;
a processing unit and a memory device, where the memory device comprises instructions, which when executed by the processing unit, allow the gateway device to:
enumerate a legacy device using the secondary network interface;
obtain a IPv6 address for the legacy device;
claim any communication for the IPv6 address occurring on the DotDot network interface;
translate the communication to a network protocol used by the secondary network interface; and
transmit the translated communication using the secondary network interface to the legacy device.

2. The gateway device of claim 1, wherein the secondary network interface supports an IEEE802.15.4 network protocol.

3. The gateway device of claim 1, wherein the secondary network interface supports a BLUETOOTH® network protocol.

4. The gateway device of claim 1, wherein the IPv6 address of the legacy device is different than an IPv6 address of the gateway device.

5. The gateway device of claim 1, wherein the gateway device obtains the IPv6 address by accessing a DHCP server.

6. The gateway device of claim 1, wherein the gateway device utilizes Stateless Address Autoconfiguration to obtain the IPv6 address.

7. The gateway device of claim 1, wherein the memory device further comprises instructions, which when executed by the processing unit, allow the gateway device to:
communicate with legacy devices using the secondary network interface;
query each legacy device to understand functionality of each legacy device; and
assign a unique IPv6 address to each function.

8. The gateway device of claim 1, wherein the memory device further comprises instructions, which when executed by the processing unit, allow the gateway device to:
communicate with additional legacy devices using the secondary network interface; and
assign a unique IPv6 address to each additional legacy device.

9. A method of configuring a legacy device to operate on a DotDot network, comprising:
using a gateway device to communicate to the legacy device using a secondary network interface;
assigning a unique IPv6 address to the legacy device;
translating a communication from a DotDot device to the unique IPv6 address to a legacy protocol; and
using the secondary network interface to transmit the translated communication to the legacy device.

10. The method of claim 9, wherein the gateway device creates an internal mapping associating the unique IPv6 address with the legacy device.

11. The method of claim 9, further comprising:
querying the legacy device to understand functionality of the legacy device; and
wherein each function of the legacy device is assigned a unique IPv6 address.

12. The method of claim 9, further comprising configuring a second legacy device to operate on the DotDot network by:
using a gateway device to communicate to the second legacy device using a second secondary network interface; and
assigning the second legacy device a second unique IPv6 address.

13. The method of claim 12, wherein the second secondary network interface is different than the secondary network interface.

14. The method of claim 12, wherein the secondary network interface utilizes a ZIGBEE® protocol.

15. The method of claim 14, wherein the second secondary network interface utilizes a BLUETOOTH® protocol.

16. The method of claim 9, further comprising:
obtaining the unique IPv6 address from a DHCP server.

17. The method of claim 9, further comprising:
obtaining the unique IPv6 address using stateless address autoconfiguration.

18. A gateway device, comprising:
a DotDot network interface;
a secondary network interface;
a processing unit and a memory device, where the memory device comprises instructions, which when executed by the processing unit, allow the gateway device to:
create a pool of unique IPv6 addresses using Stateless Address Autoconfiguration;
enumerate a legacy device using the secondary network interface;
assign a first of the unique IPv6 addresses to the legacy device; and
claim any communication for the first IPv6 address occurring on the DotDot network interface.

19. The gateway device of claim 18, further comprising instructions, which when executed by the processing unit, allow the gateway device to:
translate the communication to a network protocol used by the secondary network interface; and
transmit the translated communication using the secondary network interface to the legacy device.

20. The gateway device of claim 18, wherein the secondary network interface supports an IEEE802.15.4 network protocol or a BLUETOOTH® network protocol.
